(19) United States
(12) Patent Application Publication
(10) Pub. No.: US 2016/0355136 A1
(43) Pub. Date: Dec. 8, 2016

(54) MULTIMODE SWITCHABLE AUTOMOBILE REAR VIEW MIRROR

(71) Applicant: Chun-Hsien Kuo, Miaoli County (TW)

(72) Inventor: Chun-Hsien Kuo, Miaoli County (TW)

(21) Appl. No.: 15/157,026

(22) Filed: May 17, 2016

(30) Foreign Application Priority Data
Jun. 3, 2015 (TW) 104117924

(51) Int. Cl. B60R 1/08; G06K 9/00; H04N 7/18; H04N 5/247; B60R 1/06; B60R 1/12

(52) U.S. Cl. CPC B60R 1/081; B60R 1/06; B60R 1/12; H04N 7/181; H04N 5/247; G06K 9/00791; B60R 2001/1253; B60R 2300/8026

(57) ABSTRACT

A multimode switchable automobile rear view mirror, installed at two sides of an automobile, includes a central control module, a vehicle side condition display mirror and an image recording member. The vehicle side condition display mirror includes a mirror reflecting region and a multimode display region. The image recording member records a road surface at the side of the automobile. When the automobile progresses forward, the multimode display region is in a reflecting state to reflect the road surface at the side of the automobile. When the automobile reverses, the multimode display region changes to a first monitor display state to display a low road surface that the image recording member records on the road surface adjacent to the side and next to the tire of the automobile.

### FIELD OF THE INVENTION

The present invention relates to a rear view mirror, and particularly to a multimode switchable automobile rear view mirror.

### BACKGROUND OF THE INVENTION

For driving safety, rear view mirrors are usually installed at two sides of an automobile to readily observe positions and directions of rear approaching vehicles. Thus, when an automobile switches lanes or turns, accidents such as collisions with other vehicles can be prevented.

There are blind spots when using a rear view mirror. Thus, for example, the U.S. Pat. No. 3,337,285, “Vehicle Rear View Mirror with Convex Mirror Portion”, discloses a rear view mirror that includes an upper plane mirror and a lower convex mirror. The convex mirror is capable of totally reflecting visual blind spots that cannot be reflected by the plane mirror, hence expanding the visual range of the driver and enhancing driving safety.

However, in order to increase the horizontal viewable range, shorter objects close to automobile tires cannot be observed. Further, the convex mirror likely causes image distortion and interferes the judgment of the driver. In addition, the convex lens not only occupies a part of the area of the rear view mirror, but also provides an effect of reducing the size of an image in exchange for increasing the reflection breath. However, when the driver progresses in a straight line, instead of offering the function of increased reflection breadth, the convex mirror may result in disturbances when viewing the rear. Thus, there is a need for a solution capable of increasing the vertical viewable range and preventing image distortion as well as eliminating disturbances when viewing the rear view mirror and progressing in a straight line.

### SUMMARY OF THE INVENTION

Therefore, it is a primary object of the present invention to solve issues of the incapability of observing shorter objects close to automobile tires and image distortion.

It is another object of the present invention to solve the issue of viewing disturbances caused by a convex mirror occupying an area on a rear view mirror when a driver progresses in a straight line.

To achieve the above objects, the present invention provides a multimode switchable automobile rear view mirror. The multimode switchable automobile rear view mirror, installed at two sides of an automobile, includes a central control module, a vehicle side condition display mirror, and an image recording member. The vehicle side condition display mirror includes a mirror reflecting region and a multimode display region electrically connected to the central control module. The image recording member, electrically connected to the central control module, records a road surface at a side of the automobile. When the automobile progresses forward, the central control module controls the multimode display region to be in a reflecting state to reflect the road surface at the side of the automobile. When the automobile reverses, the central control module controls the multimode display region to change to a first monitor display state to display a low road surface image that the image recording member records on the road surface adjacent to the side of the automobile and next to a tire of the automobile.

In conclusion, the present invention provides following features.

1. The road surface adjacent to the side of the automobile and next to the tire of the automobile is recorded by the image recording member, and the low road surface image is displayed in the multimode display region. Thus, the vertical viewable range is expanded to prevent colliding into objects next to the tire.

2. The vehicle side condition display mirror is a plane mirror capable of preventing image distortion.

3. When the automobile progresses forward, the multimode display region is in a reflecting state, and may coordinate with the mirror reflecting region to serve for general mirror reflection purposes without incurring viewing disturbances of the driver.

### BRIEF DESCRIPTION OF THE DRAWINGS

FIG. 1 is a schematic diagram of the present invention during driving;

FIG. 2A is a schematic diagram of a vehicle side condition display mirror according to a first embodiment of the present invention;

FIG. 2B is a schematic diagram of a vehicle side condition display mirror when an automobile reverses according to the first embodiment of the present invention;

FIG. 2C is a schematic diagram of a vehicle side condition display mirror when a direction indicator light is switched according to the first embodiment of the present invention;

FIG. 3 is a schematic diagram of distance alert of the present invention;

FIG. 4A is a schematic diagram of a vehicle side condition display mirror when an automobile reverses according to a second embodiment of the present invention;

FIG. 4B is a schematic diagram of a vehicle side condition display mirror when a direction indicator light is switched according to the second embodiment of the present invention;

FIG. 5 is a function block diagram of the present invention;

FIG. 6 is a schematic diagram of a horizontal visual range of the present invention; and

FIG. 7 is a schematic diagram of a vertical visual range of the present invention.

### DETAILED DESCRIPTION OF THE PREFERRED EMBODIMENTS

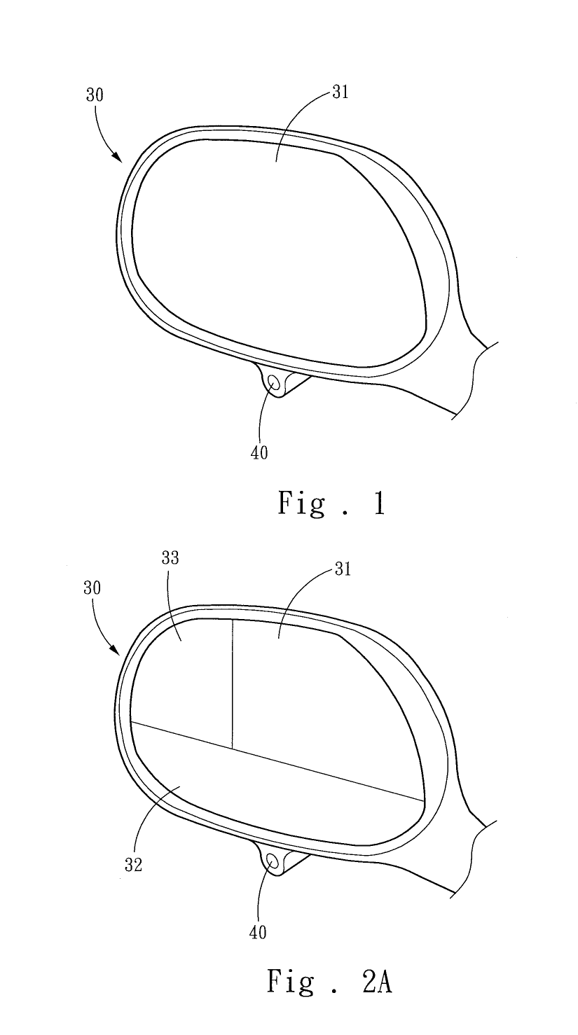

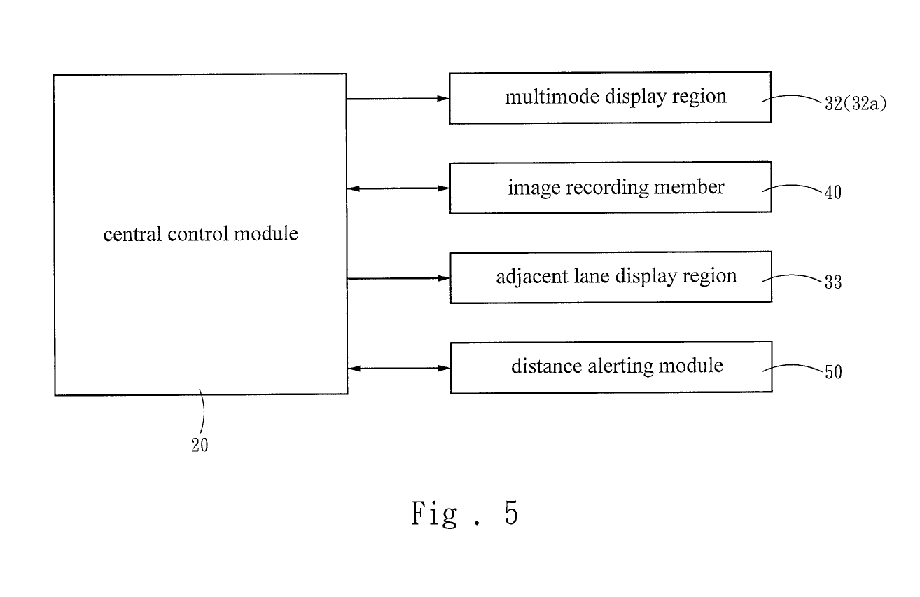

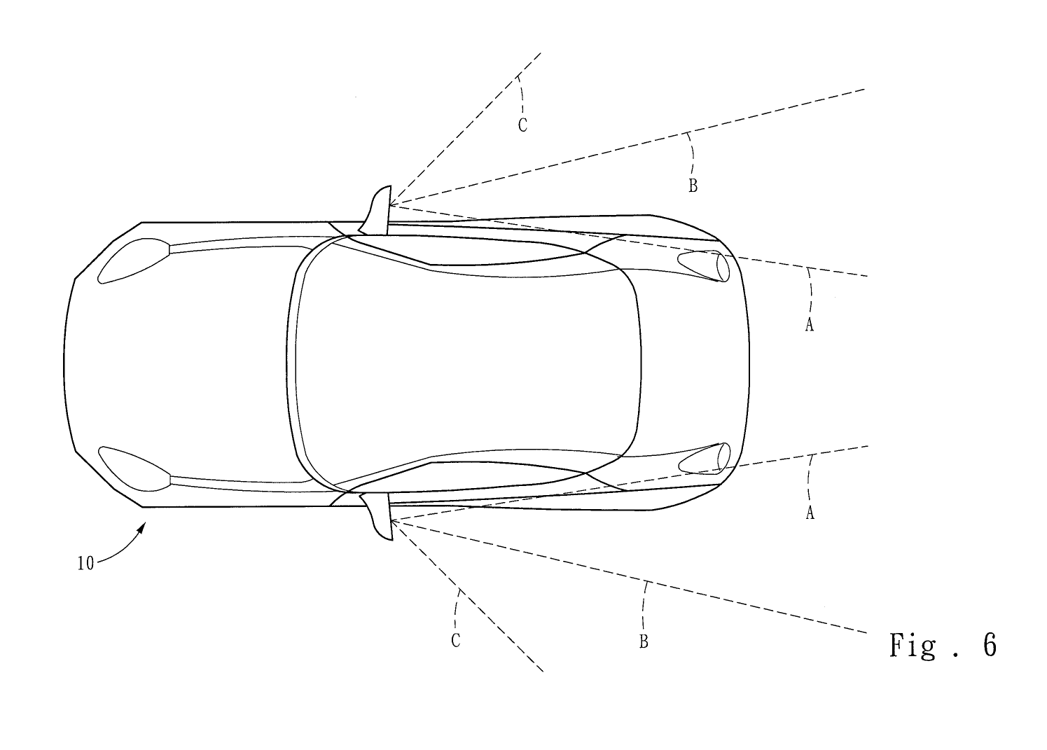

Referring to FIG. 1 to FIG. 3, FIG. 5 and FIG. 6, the present invention provides a multimode switchable automobile rear view mirror installed at two sides of an automobile 10. The multimode switchable automobile rear view mirror of the present invention includes a central control module 20, a vehicle side condition display mirror 30, an image recording member 40 and a distance alerting module 50. The vehicle side condition display mirror 30, which may be a plane mirror that prevents image distortion, includes a mirror reflecting region 31, a multimode display region 32 and a adjacent lane display region 33. The multimode display region 32 is electrically connected to the central control module 20 and disposed below the mirror reflecting region 31 to be adjacent to a tire of the automobile 10. Further, the multimode display region 32 has an area smaller than that of the mirror reflecting region 31, hence leaving the viewing experience of the driver unaffected when the driver reverses the automobile 10. The adjacent lane display region 33 is electrically connected to the central control module 20, and is disposed at one side of the mirror reflecting region 31 away from the automobile 10. The image recording member 40, electrically connected to the central control module 20, records a road surface at the side of the automobile 10, and is disposed at the periphery of the vehicle side condition display mirror 30. In this embodiment, for example but not limited to, the recoding member 40 is disposed at the vehicle side condition display mirror 30 and adjacent to the tire of the automobile 10. The distance alerting module 50, electrically connected to the central control module 20, displays a plurality of alerting lines 51 in the adjacent lane display region 33 to allow the driver to learn a distance from a vehicle at the side.

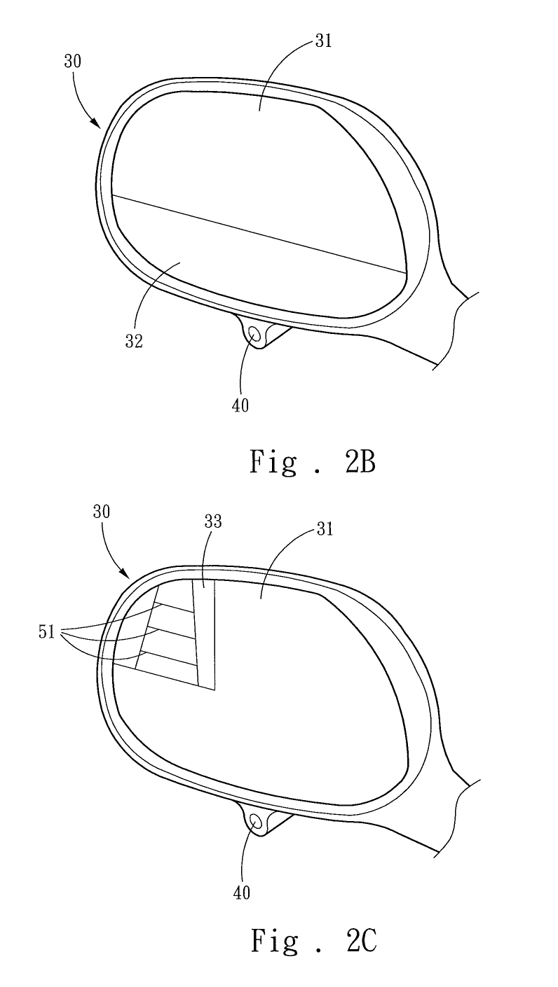

As shown in FIG. 1, when the automobile 10 progresses forward, the central control module 20 controls the multimode display region 32 and the adjacent lane display region 33 to be in a reflecting state to reflect the road surface at the side of the automobile 10. As shown in FIG. 2B, when the automobile 10 reverses, according to the switching of the reverse gear, the central control module 20 controls the multimode display region 32 to change to a first monitor display state to display a low road surface image that the image recording member 40 records on the road surface adjacent to the side of the automobile 10 and next to the tire of the automobile 10. Thus, when the automobile 10 reverses, the automobile 10 is prevented from colliding into shorter objects that cannot be easily observed next to the tire of the automobile 10.

As shown in FIG. 2C, according to the switching of the direction indictor light or the turning of the steering wheel, the central control module 20 may further control the adjacent lane display region 33 to change to a second monitor display state, and cause the image recording member 40 to record the road surface of the lane next to the automobile 10 and the adjacent lane display region 33 to display a adjacent lane image. Meanwhile, the distance alerting module 50 displays a plurality of distance alerting lines 51 in the adjacent lane display region 33 to allow the driver to easily learn the distance from a rear approaching vehicle. For example, the image recording member 40 may be in a quantity of two, and respectively record the lower road surface image and the adjacent lane image. In the embodiment, the image recording member 40 is in a quantity of one, and automatically rotates and adjusts the recording angle according to the reverse gear, the switching of the direction indicator light and the turning of the steering wheel, hence reducing the quantity of image recording member 40 needed to reduce costs.

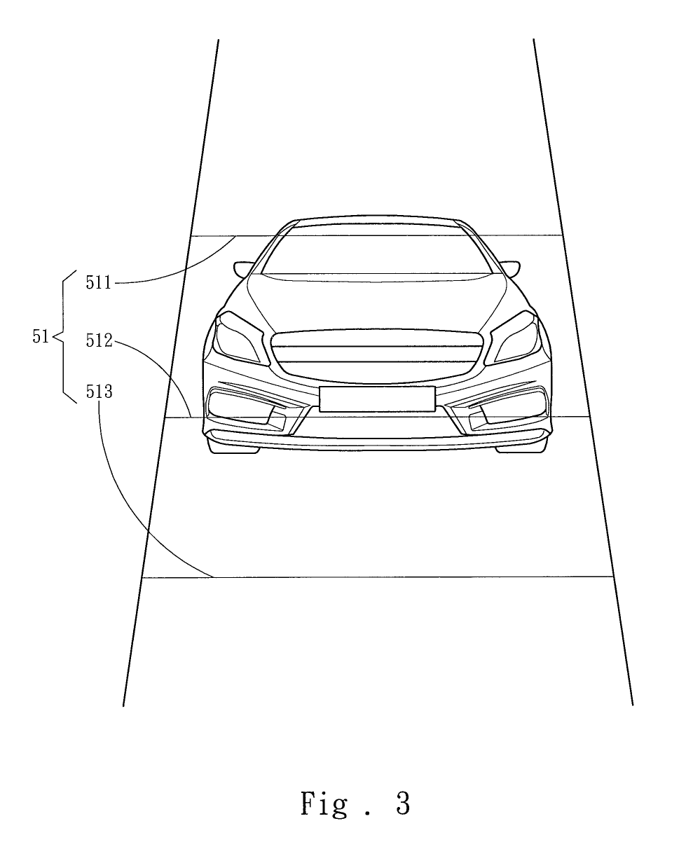

As shown in FIG. 3, the distance alerting lines 51 may be divided into a first distance alerting section 511, a second distance alerting section 512 and at third distance alerting section 513. When the front of a rear approaching vehicle is between the first distance alerting section 511 and the second alerting section 512, it means that the distance between the rear approaching vehicle and the automobile 10 is between 10 m and 15 m. When the front of the rear approaching vehicle is between the second distance alerting section 512 and the third distance alerting section 513, it means that the distance between the rear approaching vehicle and the automobile 10 is between 5 m and 10 m. Thus, the driver is provided with the basis for distance judgment, so as to reduce accidents such as collisions with other vehicles when the automobile 10 switches lanes or turns. In the embodiment, the rear approaching vehicle is located between the first distance alerting section 511 and the second distance alerting section 512, meaning that the distance between the automobile 10 and the rear approaching vehicle is 5 m to 10 m. In addition, the distance alerting lines 51 may be in different colors to achieve an alerting effect. For example, the first distance alerting section 511 may be in blue, the second distance alerting section 512 may be in yellow, and the third distance alerting section 513 may be in red, so as to accordingly gradually increase the alerting level according to the distance from the approaching vehicle.

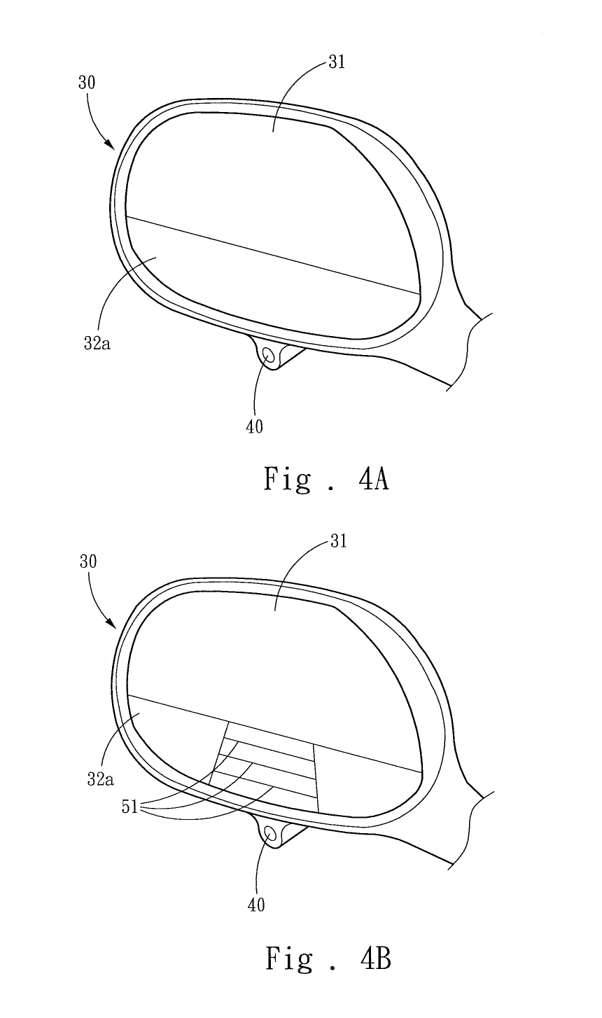

FIG. 4A and FIG. 4B show a second embodiment of the present invention. Referring to FIG. 4A and FIG. 4B, the vehicle side condition display mirror 30 includes only the mirror reflecting region 31 and a multimode display region 32a. The multimode display region 32a is disposed below the mirror reflecting region 31. FIG. 4A shows that the central control module 20 controls the multimode display region 32a to change to the first monitor display state according to the switching of the reverse gear to display the lower road surface image. FIG. 4B shows that central control module 20 controls the multimode display region 32a to change to the second monitor display state according to the switching of the direction indicator light to display the vehicle adjacent lane image and the distance alerting lines 51.

Referring to FIG. 6, an image between the segment A to the segment B can be viewed from a common rear view mirror. However, in the present invention, the road surface of the lane next to the automobile 10 is recorded by the image recording member 40, and the adjacent lane image is displayed in the multimode display region 32 or 32a or the adjacent lane display region 33. Thus, the image between the section A and the section C can be observed to expand the visual range of the driver and reduce blind spots to further enhance driving safety.

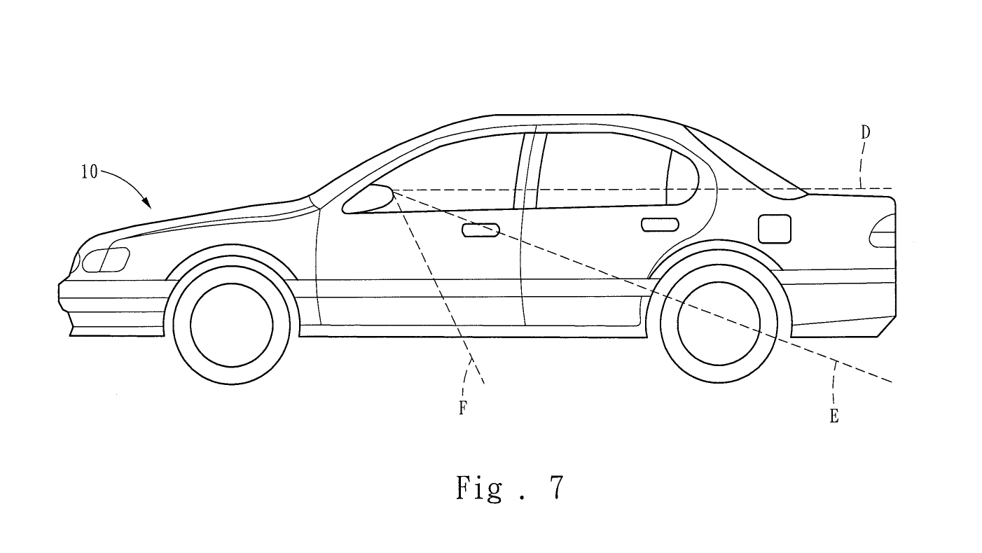

As shown in FIG. 7, the road surface adjacent to the side of the automobile 10 and next to the tire of the automobile 10 is recorded by the image recording member 40, and the low road surface image is displayed in the multimode display region 32 or 32a. Thus, the visual range of the driver may be expanded from the image between the segment D to the segment E to an image between the segment D to the segment F, so as to prevent the automobile 10 from colliding into shorter and smaller objects that are less likely observed next to the tire of the automobile 10 when the automobile 10 reverses.

In conclusion, the present invention provides following features.

1. The road surface adjacent to the side of the automobile and next to the tire of the automobile is recorded by the image recording member, and the low road surface image is displayed in the multimode display region. Thus, when the automobile reverses, the automobile is prevented from colliding into shorter and smaller objects less likely observed next to the tire of the automobile.

2. The vehicle side condition display mirror is a plane mirror capable of preventing image distortion.

3. A plurality of distance alerting lines are displayed in the adjacent lane display region by the distance alerting module. As such, the driver may easily learn the distance from the rear approaching vehicle to reduce accidents such as colliding into other vehicles when the automobile switches lanes or turns.

4. The road surface of the lane next to the automobile is recorded by the image recording member, and the adjacent lane image is displayed in the multimode display region or the adjacent lane display region. Thus, the visual range of the driver can be expanded to reduce blind spots and enhance driving safety.

5. When the automobile progresses forward, the multimode display region and the adjacent lane display region are in a reflecting state, and may coordinate with the mirror reflecting region to serve for general mirror reflection purposes without incurring viewing disturbances of the driver.

6. The image recording member automatically adjusts the recording angle according to the switching of the reverse gear and the direction indicator light as well as the turning of the steering wheel, hence reducing the number of image recording member needed to reduce costs.

7. When the automobile is in a reversing state or turning is sensed, the multimode display region and the adjacent lane display region are intelligently activated to optimize operation convenience of the driver to meet application needs.

What is claimed is:

1. A multimode switchable automobile rear view mirror, installed to two sides of an automobile, comprising:
a central control module;
a vehicle side condition display mirror, comprising a mirror reflecting region and a multimode display region electrically connected to the central control module; and
an image recording member, electrically connected to the central control module, for recording a road surface at a side of the automobile;
wherein, when the automobile progresses forward, the central control module controls the multimode display region to be in a reflecting state to reflect the road surface at the side of the automobile; when the automobile reverses, the central control module controls the multimode display region to change to a first monitor display state to display a low road surface image that the image recording member records on the road surface adjacent to the side of the automobile and next to a tire of the automobile.

2. The multimode switchable automobile rear view mirror of claim 1, wherein the image recording member is disposed at a periphery of the vehicle side condition display mirror.

3. The multimode switchable automobile rear view mirror of claim 1, wherein the multimode display region is disposed below the mirror reflecting region to be adjacent to the tire of the automobile.

4. The multimode switchable automobile rear view mirror of claim 3, wherein the central control module controls the multimode display region to change to the first monitor display state to display the low road surface according to the switching of a reverse gear.

5. The multimode switchable automobile rear view mirror of claim 1, wherein the area of the multimode display region is smaller than the area of the mirror reflecting region.

6. The multimode switchable automobile rear view mirror of claim 1, wherein the vehicle side condition display mirror further comprises a adjacent lane display region disposed at the mirror reflecting region away from the automobile.

7. The multimode switchable automobile rear view mirror of claim 6, wherein the central control module controls the adjacent lane display region to change to a second monitor display state according to one of switching of a direction indicator light or turning of a steering wheel, causes the image recording member to record the road surface of a lane next to the automobile and displays a adjacent lane image in the adjacent lane display region.

8. The multimode switchable automobile rear view mirror of claim 7, further comprising:
a distance alerting module, electrically connected to the central control module;
wherein, when the adjacent lane display region displays the adjacent lane image, the distance alerting module displays a plurality of distance alerting lines in the adjacent lane display region.

9. The multimode switchable automobile rear view mirror claim 1, wherein the central control module controls the multimode display region to change to a second monitor display state according to switching of a direction indictor light, causes the image recording member to record the road surface of a lane next to the automobile, and displays a adjacent lane image in the multimode display region.

10. The multimode switchable automobile rear view mirror of claim 9, further comprising:
a distance alerting module, electrically connected to the central control module;
wherein, when the multimode display region displays the adjacent lane image, the distance alerting module displays a plurality of distance alerting lines in the multimode display region.
